(19) United States
(12) Patent Application Publication
(10) Pub. No.: US 2017/0010404 A1
(43) Pub. Date: Jan. 12, 2017

(54) LINEAR LIGHT SOURCE WITH FLEXIBLE PRINTED CIRCUIT

(71) Applicant: Pixon Technologies Corp., New Taipei City (TW)

(72) Inventor: Yen-Chieh CHEN, New Taipei City (TW)

(21) Appl. No.: 14/795,552

(22) Filed: Jul. 9, 2015

(51) Int. Cl. F21V 8/00; F21K 99/00

(52) U.S. Cl. CPC G02B 6/0061; G02B 6/0043; G02B 6/0073; G02B 6/0091; G02B 6/0088; F21K 9/52

(57) ABSTRACT

A linear light source assembly including a light guide bar with patterned light emitting surface, a reflective holder, a light emitting diode (LED) light source module, and a flexible printed circuit (FPC) is disclosed. The light guide bar is an elongated polygonal transparent material with a light-scattering patterned light emitting surface where the light exits. The FPC is a flexible plastic substrate with a plurality of conductive traces and a plurality of FPC holes in the flexible plastic substrate. The light guide bar is disposed in the holder. The LED light source module is attached to the FPC. Holder posts are inserted into the FPC holes to align and hold the FPC with LED light source module to the holder and position the LED light source module adjacent to a light-receiving end of the light guide bar.

### BACKGROUND OF THE INVENTION

Field of the Invention

The present invention relates to a linear light source. More specifically, the present invention discloses a linear light source having a light guide bar with patterned light emitting surface and a light emitting diode module connected to a flexible printed circuit to provide a compact and economical linear light source assembly.

Description of the Prior Art

Conventional scanners use a linear light source to illuminate a target in order to acquire an image of the target. The quality of the acquired image is greatly dependent on the linear light source performance. Any inconsistencies in the intensity or uniformity of the light source will affect the accuracy of the image.

The quality of the acquired image is also degraded if the scanned target is not in a fixed focal range and exceeds the effective focal range tolerance of the light source.

Additionally, the shape of conventional linear light sources is typically designed to make it easier to be fabricated or molded. However, due to the constraints of the design the efficiency of light propagation in terms of diffusion and scattering or uniformity control is limited.

Furthermore, although different approaches have been used to improve the light uniformity and light intensity, greater improvements are still sought after to optimize the energy conservation, improve the intensity and uniformity of the emitted light, and enhance the uniformity of beaming light within beaming light's effective focal range.

Moreover, conventional linear light sources are not as compact or as cost efficient as current demands require. To remain competitive in the market, light sources need to be smaller and less expensive to manufacture.

Therefore, there is need for an improved linear light source with superior light intensity and light uniformity that utilizes a flexible printed circuit to provide a more compact and cost effective light source.

### SUMMARY OF THE INVENTION

To achieve these and other advantages and in order to overcome the disadvantages of the conventional methods in accordance with the purpose of the invention as embodied and broadly described herein, the present invention provides a compact and cost effective linear light source assembly that improves the definition and accuracy of image acquisition.

The linear light source assembly of the present invention comprises a light guide bar with patterned light emitting surface, a reflective holder, a light emitting diode (LED) light source module, and a flexible printed circuit (FPC).

In the present invention the light guide bar is disposed in the reflective holder and the FPC with attached LED light source module is connected to the holder.

The light guide bar comprises an elongated polygonal transparent material. The light guide bar is disposed in a holder such as, for example, a reflective holder or reflective windowed box. One surface of the light guide bar is a light emitting surface where the light exits.

The LED light source module comprises, for example, a single LED or plurality of LEDs in an LED package. The LED light source module comprises, for example, a standard top side LED module used in LED TVs or sign boards. Since the production of such standard LED module is very large and increasing, the availability is widespread, the standard LED module is a key driving force for lowering unit cost for the linear light source assembly with FPC. This cost reduction is an advantage of the present invention.

The LED light source module is positioned adjacent to a light-receiving end of the light guide bar.

Also, the LED light source module is attached to the FPC utilizing surface-mount technology (SMT) and surface-mount device (SMD) techniques.

The FPC comprises a flexible plastic substrate and a plurality of conductive traces. The FPC further comprises a plurality of FPC holes in the flexible plastic substrate.

The holder surrounds all surfaces of the light guide bar except for the light emitting surface. The holder comprises a windowed box wherein the light guide bar is enclosed in the box except for the light emitting surface, which emits light through the opening or window of the box. The surfaces of the light guide bar surrounded by the reflective holder are reflective surfaces for reflecting light.

The holder further comprises a plurality of holder posts disposed on an end of the holder. During assembly the holder posts are inserted into the FPC holes to align and hold the FPC with LED light source module to the holder.

After light from the LED light source module enters the light-receiving end or ends of the light guide bar, the light may be reflected off any of the reflective surfaces. The light eventually exits the light guide bar through the light emitting surface. The light emitting surface further comprises a light-scattering pattern that serves to diffuse the light. The light-scattering pattern can comprise a series of notches and/or ridges that are formed such that they vary along the length of the light guide body and may be slightly ramped or sloped from a side view.

As mentioned above, the light-scattering pattern diffuses the light since the light is reflected by one or more of the notches or ridges. The light continues to propagate through the light guide bar from the light-receiving end toward the opposite end before exiting the surface either through a notch or ridge. The light exiting the light emitting surface also refracts at a variety of different angles through the various notches and ridges.

The present invention provides a linear light source assembly for enhancing the uniformity of beaming light within the beaming light's effective focal range. The linear light source assembly provides a light source with greater emitted or beaming light uniformity that can accurately detect the target without loss caused by uneven or non-uniform intensity. The present invention also provides a linear light source with high intensity that can repeatedly reflect light in order to optimally conserve the light energy and greatly enhance the intensity.

The present invention further provides an improved linear light source with superior light intensity and light uniformity that utilizes a flexible printed circuit and LED light source module SMD to provide a more compact and cost effective light source.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is 3-dimensional drawing illustrating a linear light source assembly according to an embodiment of the present invention;

FIG. 1B is exploded view 3-dimensional drawing illustrating a linear light source assembly according to an embodiment of the present invention;

FIG. 2A is a drawing illustrating a light guide bar of a linear light source assembly according to an embodiment of the present invention;

FIG. 2B is a cross-sectional drawing illustrating a light guide bar in a holder of a linear light source assembly according to an embodiment of the present invention;

FIG. 2C is a cross-sectional drawing illustrating a light-scattering pattern of a light emitting surface of a light guide bar of a linear light source assembly according to an embodiment of the present invention;

FIG. 3A is a drawing illustrating a reflective holder of a linear light source assembly according to an embodiment of the present invention;

FIG. 3B is a cross-sectional drawing illustrating a holder and light guide bar of a linear light source assembly from view A-A of FIG. 3A according to an embodiment of the present invention;

FIG. 3C is a cross-sectional drawing illustrating a holder and light guide bar of a linear light source assembly from view B-B of FIG. 3A according to an embodiment of the present invention;

FIG. 4 is a drawing illustrating a flexible printed circuit of a linear light source assembly according to an embodiment of the present invention;

FIG. 5A is a 3-dimensional drawing illustrating a light emitting diode light source module of a linear light source assembly according to an embodiment of the present invention;

FIG. 5B is a front view drawing illustrating a light emitting diode light source module of a linear light source assembly according to an embodiment of the present invention;

FIG. 5C is a side view drawing illustrating a light emitting diode light source module of a linear light source assembly according to an embodiment of the present invention;

FIG. 5D is a rear view drawing illustrating a light emitting diode light source module of a linear light source assembly according to an embodiment of the present invention;

FIG. 6A is an exploded view drawing illustrating a linear light source assembly according to an embodiment of the present invention;

FIG. 6B is an exploded view drawing illustrating a linear light source assembly according to an embodiment of the present invention;

FIG. 7A is a front view drawing illustrating a light emitting diode light source module and flexible printed circuit of a linear light source assembly according to an embodiment of the present invention;

FIG. 7B is a side view drawing illustrating a light emitting diode light source module and flexible printed circuit of a linear light source assembly according to an embodiment of the present invention;

FIG. 8A is a 3-dimensional drawing illustrating a linear light source assembly in an image acquisition device sub-module housing according to an embodiment of the present invention; and

FIG. 8B is a cross-sectional drawing illustrating a linear light source assembly in an image acquisition device sub-module housing according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

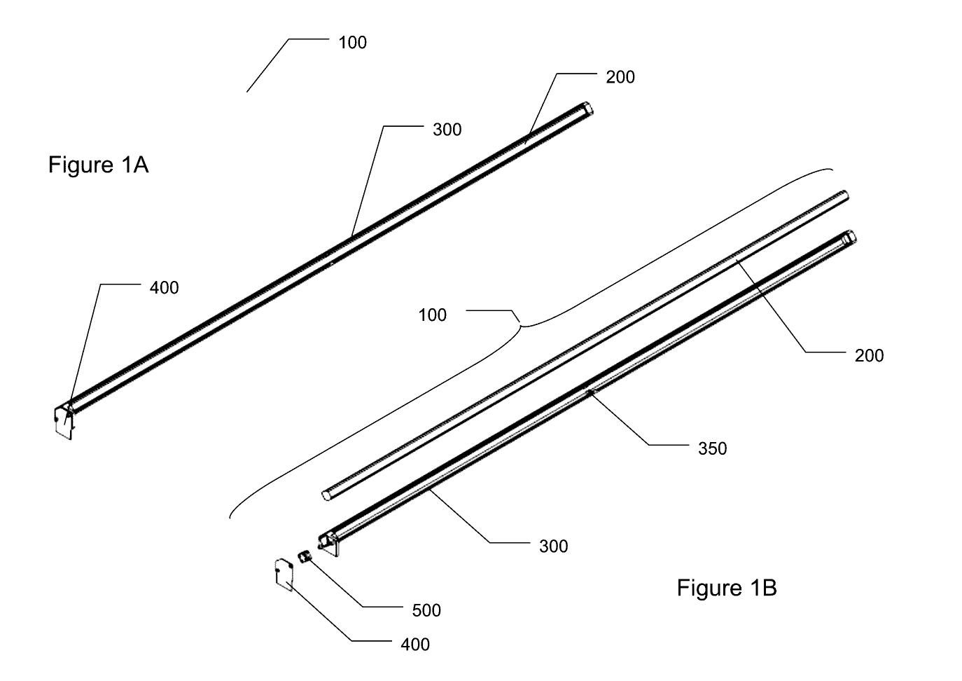

Refer to FIG. 1A, which is 3-dimensional drawing illustrating a linear light source assembly according to an embodiment of the present invention and refer to FIG. 1B, which is exploded view 3-dimensional drawing illustrating a linear light source assembly according to an embodiment of the present invention.

The linear light source assembly 100 of the present invention comprises a light guide bar 200, a reflective holder 300, a flexible printed circuit (FPC) 400, and a light emitting diode (LED) light source module 500.

The light guide bar 200 is inserted into an opening in the end of the reflective holder 300 until the light guide bar 200 is held inside the interior cavity of the holder that matches the shape of the light guide bar 200. At least one holder clasp 350 is provided to retain the light guide bar 200 inside the holder 300. In the embodiment illustrated in FIG. 1B a holder clasp 350 is disposed in the center of the holder 300. In other embodiments a greater number of holder clasps 350 are utilized.

The LED light source module 500 is attached to the FPC 400 and the FPC 400 is attached to the end of the holder 300 positioning the LED light source module 500 against the light receiving end of the light guide bar 200.

Electrical power is supplied to the LED light source module 500 from an image acquisition device sub-module via conductive traces on the FPC 400. When turned on the LED light source module 500 emits light into the light receiving end of the light guide bar 200. The light is travels through the light guide bar 200 and is reflected by the reflective holder 300 and then exits a light emitting surface of the light guide bar 200.

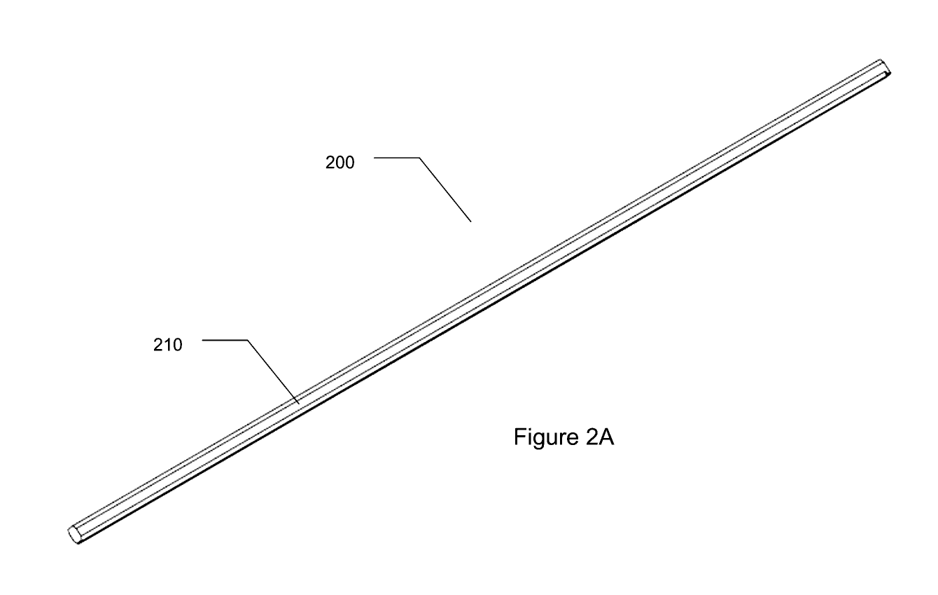

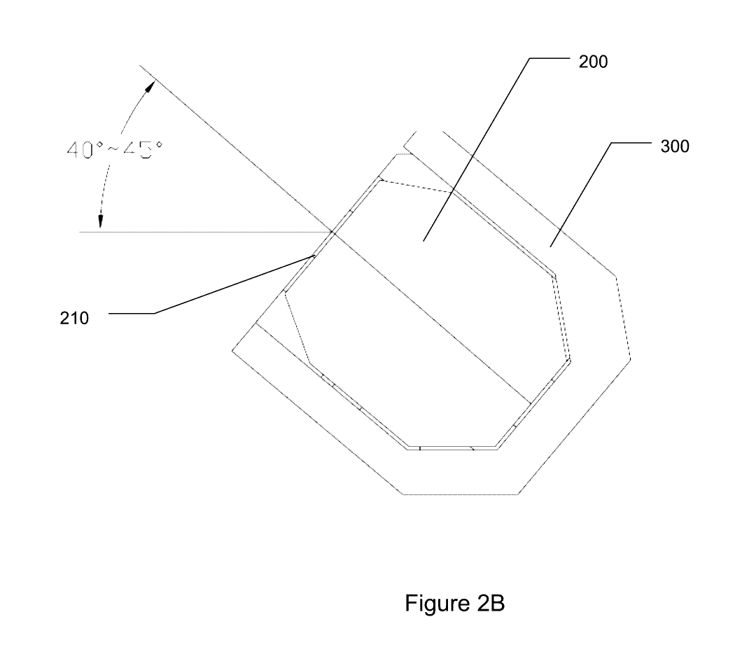

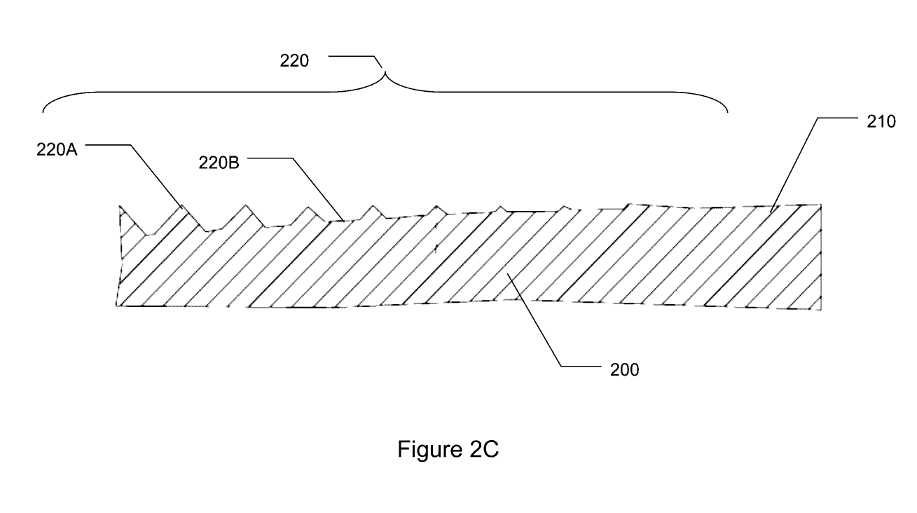

Refer to FIG. 2A, which is a drawing illustrating a light guide bar of a linear light source assembly according to an embodiment of the present invention and refer to FIG. 2B, which is a cross-sectional drawing illustrating a light guide bar in a holder of a linear light source assembly according to an embodiment of the present invention.

The light guide bar 200 comprises a polygonal cylinder of a transparent or translucent material and is illustrated as an octagonal cylinder in this embodiment. However, in other embodiments the number of sides of the light guide bar 200 is different. The light guide bar 200 is primarily used for converting the spot light source of the LED light source module into a linear light source. One surface of the light guide bar 200 is a light emitting surface 210 for linearly emitting the light. The other surfaces are reflecting surfaces used with the reflective holder 300 for reflecting the light.

Refer to FIG. 2C, which is a cross-sectional drawing illustrating a light-scattering pattern of a light emitting surface of a light guide bar of a linear light source assembly according to an embodiment of the present invention.

In order to improve intensity and increase uniformity, in some embodiments the light emitting surface 210 is sloped and notched to form a light-scattering pattern 220 on the light emitting surface 210 of the light guide bar 200. The present invention forms the notches 220B and ridges 220A on the surface of the light emitting surface 210. If the notches 220B are formed on a reflective plane, the light is output after being reflected and refracted in the body of the light guide bar 200. Although this can also improve the uniformity, the residual notch or indentation shadow will be obvious after exceeding a certain range. Therefore, it is preferred to form the notches 220B on the light emitting surface 210. As a result, the present invention not only reduces the influence or shadow of the indentations or notches but also improves the uniformity.

The light is reflected and refracted by the reflective surfaces of the light guide bar 200 and the reflective holder, and then output from the light-scattering pattern 220 of the light emitting surface 210. With different notch angles, the light can be controlled more uniformly. Because the light is directly output after being uniformed, the indentation shadow is not obvious, and the effective focal range tolerance of the light can also be improved.

In the present invention, the design of the notches 220B or indentations is closely related to the light uniformity. The incline angle of the notch 220B is typically between 0.03 to 0.15 degrees, and the angle can be gradually or sectionally increased. For example, the incline angle of a section is a fixed value between 0.03 to 0.09 degrees (such as 0.07), and the incline angle of another section is a fixed value between 0.09 to 0.15 degrees (such as 0.11). For example, if illustrated by increasing the incline angle over 3 sections, the incline angle of a first section could be a fixed value between 0.03 to 0.05 degrees (such as 0.04), the angle of a second section could be fixed value between 0.05 to 0.10 degrees (such as 0.08), and the angle of a third section could be a fixed value between 0.10 to 0.15 degrees (such as 0.12).

Obviously, other angles of incline can be utilized depending on requirements. For example, in some embodiments of the present invention the incline angle is linearly or logarithmically increased from one end of the light guide bar 200 to the other.

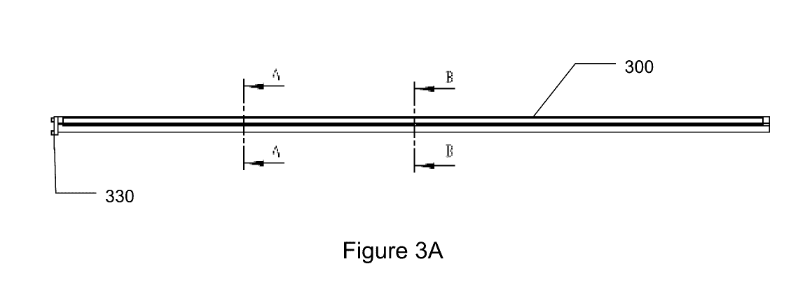

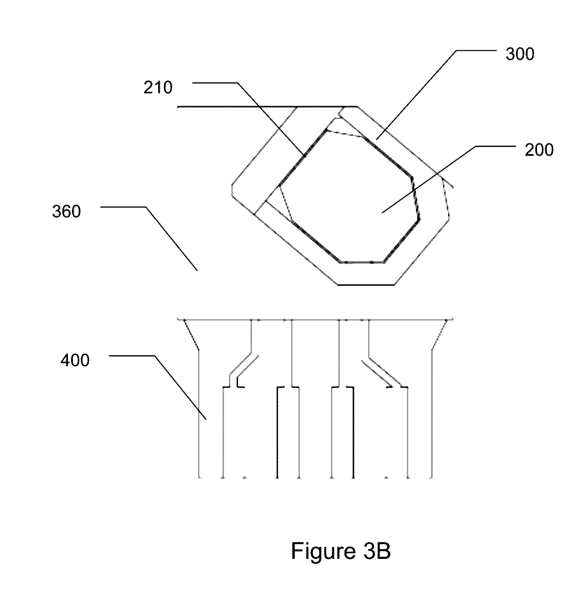

Refer to FIG. 3A, which is a drawing illustrating a reflective holder of a linear light source assembly according to an embodiment of the present invention, refer to FIG. 3B, which is a cross-sectional drawing illustrating a holder and light guide bar of a linear light source assembly from view A-A of FIG. 3A according to an embodiment of the present invention, and refer to FIG. 3C, which is a cross-sectional drawing illustrating a holder and light guide bar of a linear light source assembly from view B-B of FIG. 3A according to an embodiment of the present invention.

The reflective holder 300 comprises an elongated body for holding the light guide bar 200 and reflecting light towards the light emitting surface 210 of the light guide bar 200. The internal holder cavity of the holder 300 is shaped to conform with external surfaces of the light guide bar 200.

The holder 300 further comprises a plurality of holder posts 330 disposed on a holder end plate 360 of the holder 300. The plurality of holder posts 330 are inserted into FPC holes of the FPC 400 and hold the FPC 400 to the holder 300 and align the LED light source module to the light receiving end of the light guide bar 200.

The holder 300 further comprises at least one holder clasp 350 for holding the light guide bar 200 inside the holder cavity. The holder clasp 350 extends from the walls of the holder 300 and grasps the forward surfaces of the light guide bar 200 on both sides of the light emitting surface 210.

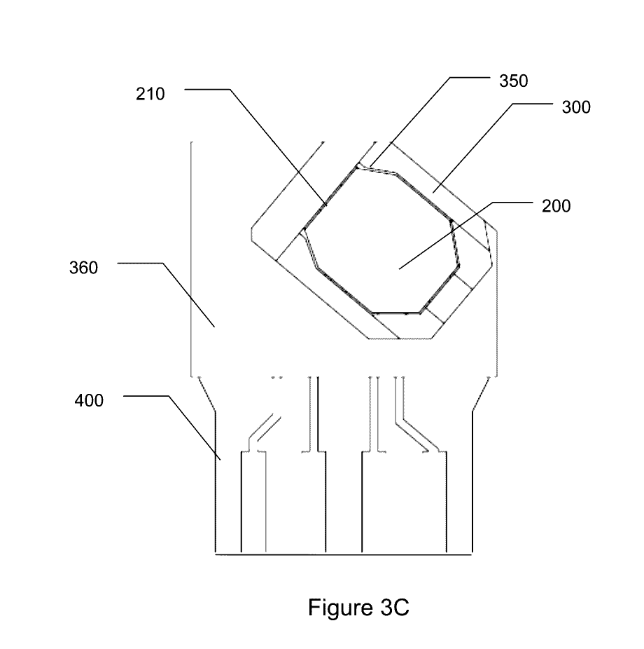

Refer to FIG. 4, which is a drawing illustrating a flexible printed circuit of a linear light source assembly according to an embodiment of the present invention.

The FPC 400 comprises a flexible substrate 430, a plurality of FPC conductive traces 410, and a plurality of FPC holes 420.

The plurality of conductive traces 410 provide a path for electrically coupling the LED light source module and a power source of an image acquisition device sub-module.

The plurality of FPC holes 420 provide a means of attaching the FPC to the holder by inserting the holder posts into the FPC holes 420.

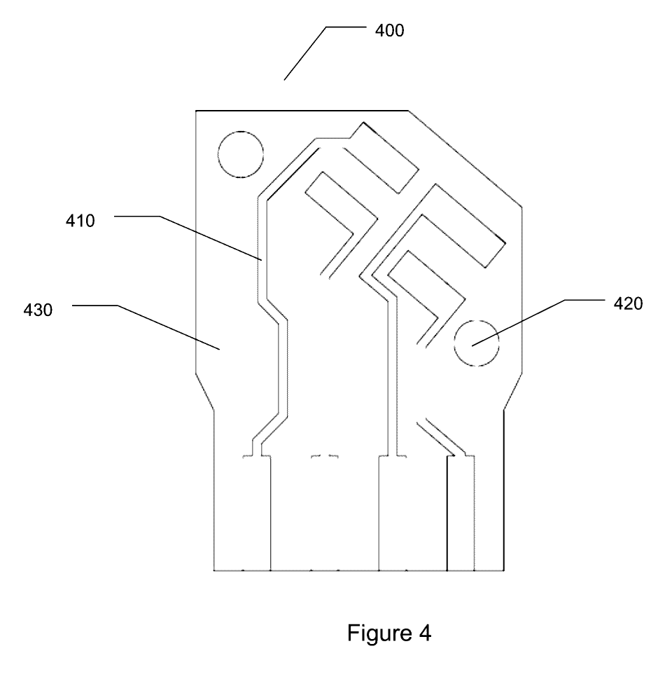

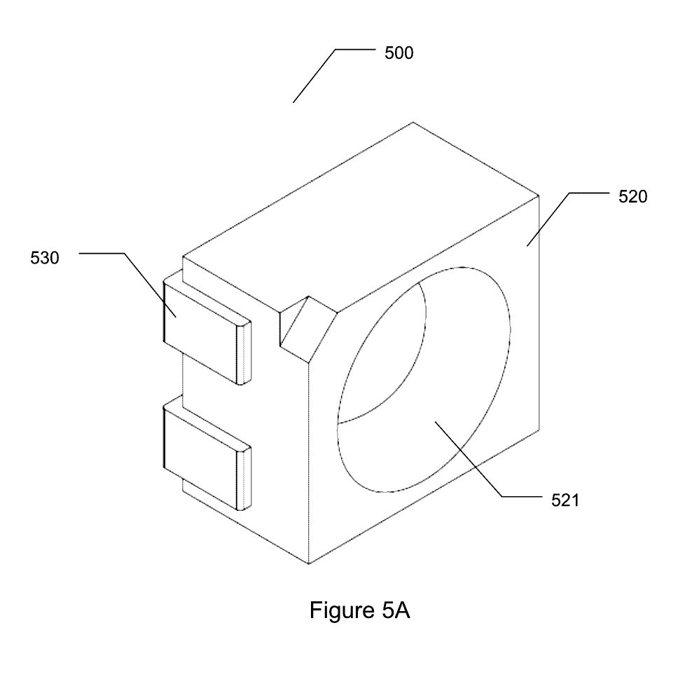

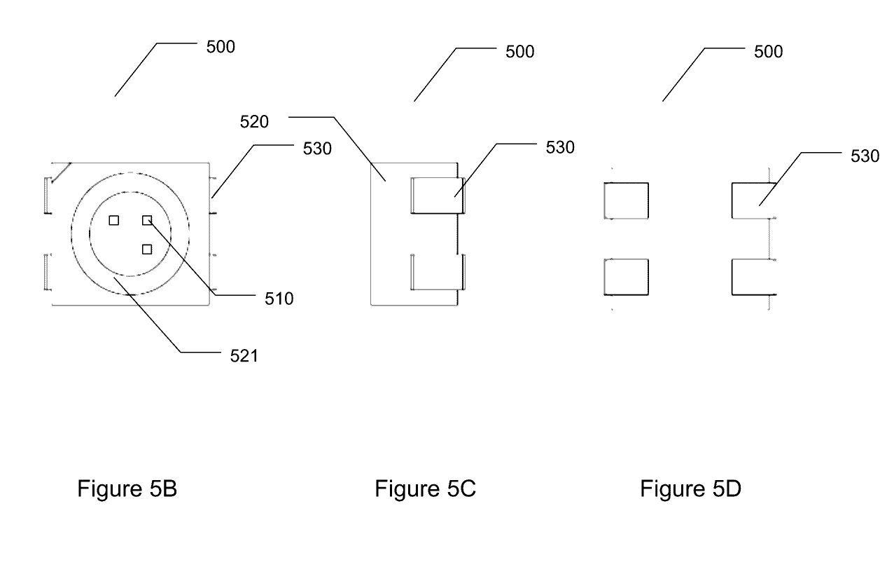

Refer to FIG. 5A, which is a 3-dimensional drawing illustrating a light emitting diode light source module of a linear light source assembly according to an embodiment of the present invention, refer to FIG. 5B, which is a front view drawing illustrating a light emitting diode light source module of a linear light source assembly according to an embodiment of the present invention, refer to FIG. 5C, which is a side view drawing illustrating a light emitting diode light source module of a linear light source assembly according to an embodiment of the present invention, and refer to FIG. 5D, which is a rear view drawing illustrating a light emitting diode light source module of a linear light source assembly according to an embodiment of the present invention.

The LED light source module 500 provides a light source for the linear light source assembly. The LED light source module 500 comprises a plurality of LEDs 510, a module housing 520, and a plurality of LED conductors 530.

The LEDs 510 are disposed in a module housing indentation 521 of the module housing 520. The plurality of LED conductors 530 provides conductive pathways for electrical power from the FPC conductive traces to the LEDs 510.

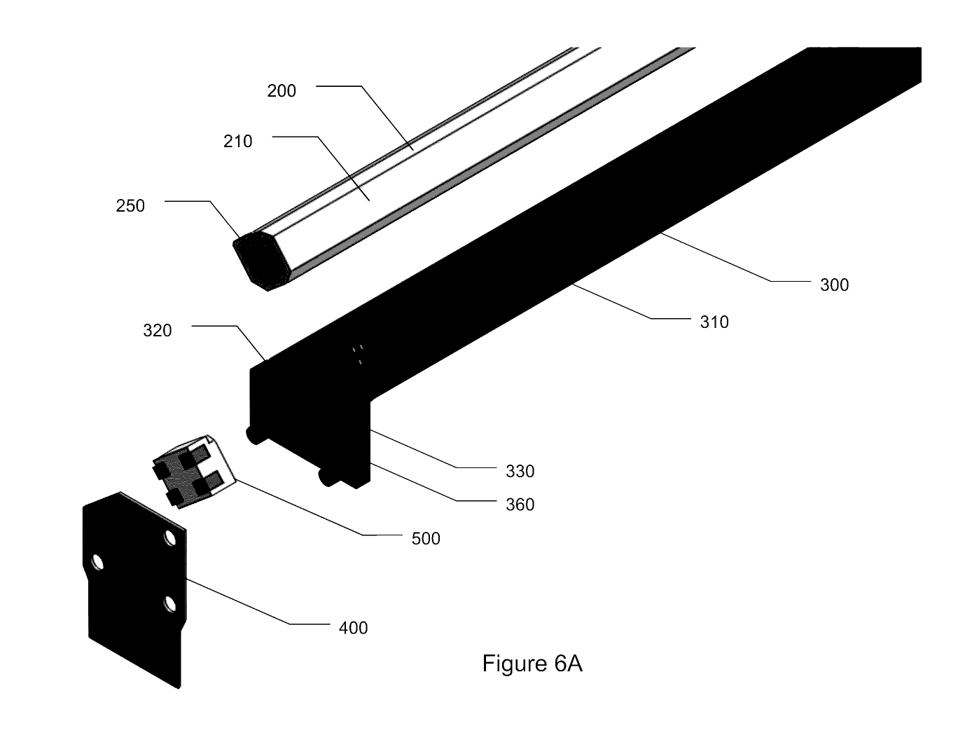

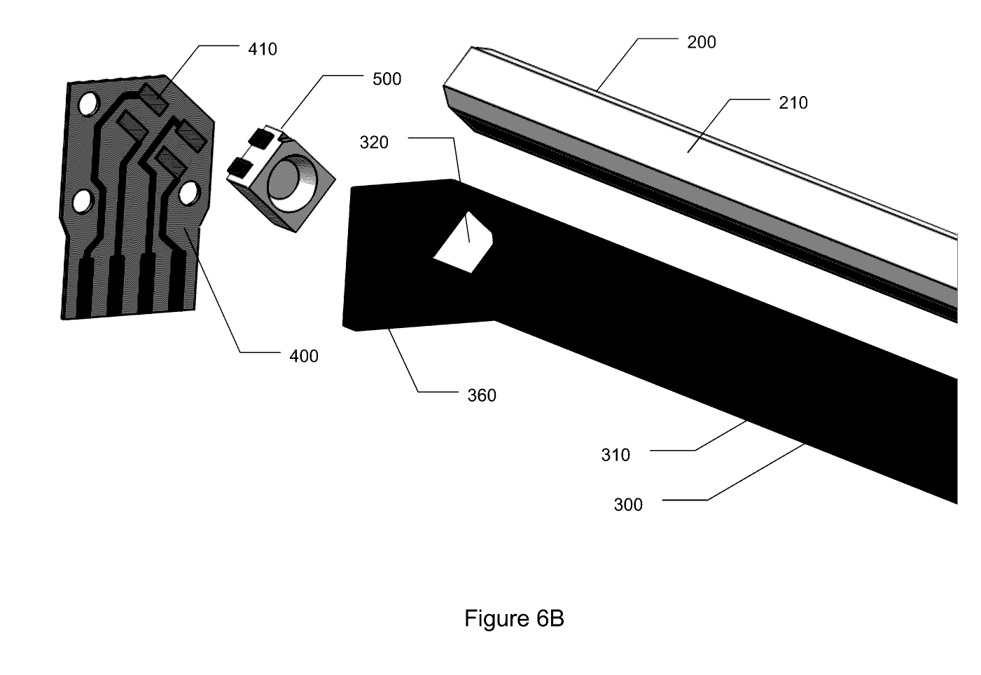

Refer to FIG. 6A, which is an exploded view drawing illustrating a linear light source assembly according to an embodiment of the present invention and refer to FIG. 6B, which is an exploded view drawing illustrating a linear light source assembly according to an embodiment of the present invention.

One end of the light guide bar 200 is a light receiving end 250. When the LED light source module 500 and the light guide bar 200 are assembled together, the light receiving end 250 corresponds to the LEDs of the LED light source module 500, so that the light from the LEDs pass into the light guide bar 200 via the light receiving end 250 and is distributed through the structure of the light guide bar 200.

The reflective holder 300 covers most of the light guide bar 200 except for the light emitting surface 210 thereby enhancing the reflection effect and improves the output intensity. An emission opening is formed in the reflective holder 300 corresponding to the light emitting surface 210 of the light guide bar 200 for allowing the light to pass. The other surfaces of the light guide bar 200 are reflective surfaces and are covered by the reflective holder 300.

After entering the light guide bar 200, the light is reflected by the reflective surfaces of the light guide bar 200 and the reflective holder 300 in order to enhance the intensity. After being reflected, the light will be emitted from the light emitting surface 210 through the emission opening of the holder 300.

During assembly, the light guide bar 200 is inserted into a holder opening 320 in the end of the reflective holder 300 until the light guide bar 200 is held inside the holder cavity 310 of the holder 300 that matches the shape of the light guide bar 200.

When the light guide bar 200 is fully inserted, the light guide bar 200 is encased in the reflective holder 300 except for the light emitting surface 210 of the light guide bar 200. Since a function of the reflective holder 300 is to reflect the light, the color of the reflective holder 300 is selected from those having greater reflectivity, such as, for example, white, silver, or silvery white.

After the light guide bar 200 has been fully inserted into the holder cavity 310 of the holder 300 the FPC 400 with attached LED light source module 500 is attached to the holder 300. The holder posts 330 on the holder end plate 360 are inserted into the FPC holes of the FPC 400. Staking such as, for example, heat staking or thermoplastic staking is performed to deform the holder posts 330 and locks the FPC 400 and the holder 300 together and aligns the LEDs of the LED light source module 500 with the light receiving end of the light guide bar 200.

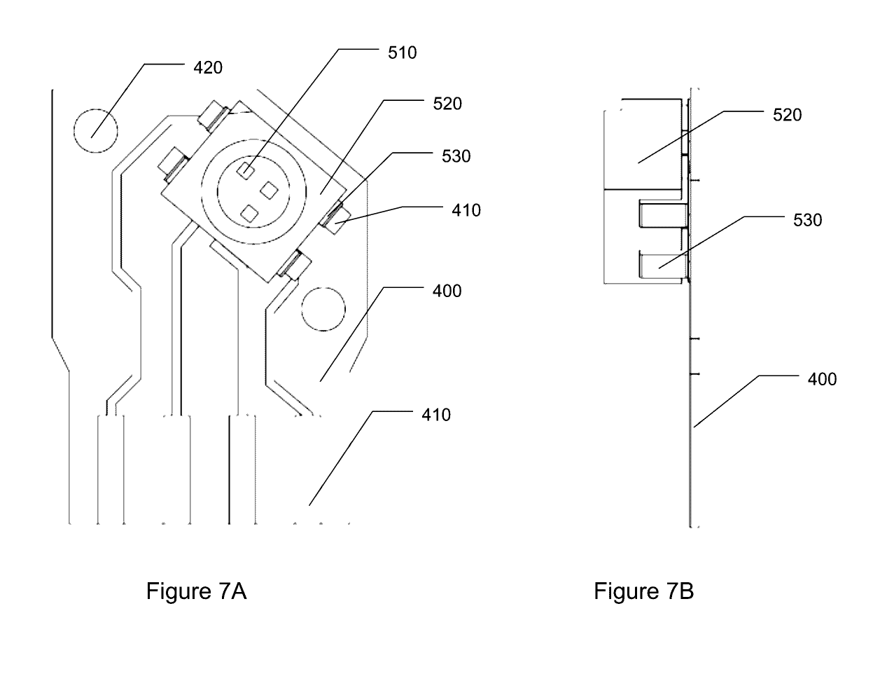

Refer to FIG. 7A, which is a front view drawing illustrating a light emitting diode light source module and flexible printed circuit of a linear light source assembly according to an embodiment of the present invention and refer to FIG. 7B, which is a side view drawing illustrating a light emitting diode light source module and flexible printed circuit of a linear light source assembly according to an embodiment of the present invention.

The LED light source module 500 comprises a surface-mount device (SMD). The LED light source module 500 is attached to the FPC utilizing surface-mount technology (SMT) and surface-mount device (SMD) techniques. For example, surface-mount soldering is performed to connect and electrically couple the LED conductors 530 and FPC conductive traces 410 and attach the LED light source module 500 and the FPC 400 together.

After the LED light source module 500 and the FPC 400 are connected, the FPC conductive traces 410 provide a conductive path for electrical power to the LEDs 510 of the LED light source module 500 from an image acquisition device sub-module.

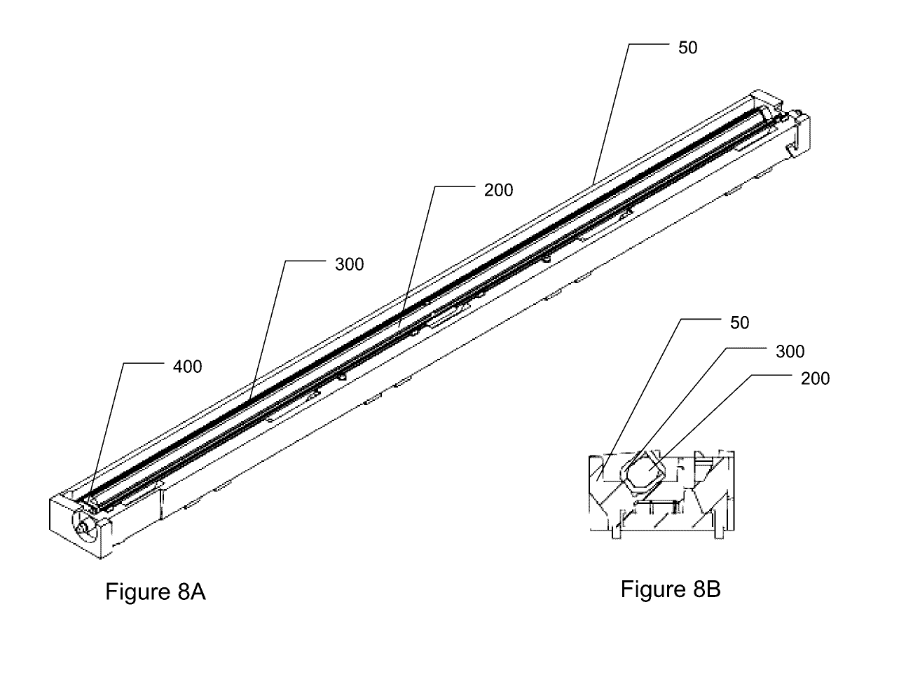

Refer to FIG. 8A, which is a 3-dimensional drawing illustrating a linear light source assembly in an image acquisition device sub-module housing according to an embodiment of the present invention and refer to FIG. 8B, which is a cross-sectional drawing illustrating a linear light source assembly in an image acquisition device sub-module housing according to an embodiment of the present invention.

After the linear light source assembly of the present invention has been assembled, the linear light source assembly is installed in an image acquisition device sub-module housing 50. The image acquisition device sub-module housing 50 holds the linear light source assembly in place so that the linear light source assembly remains in correct alignment for optimal performance during use of the main image acquisition device.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A linear light source assembly, comprising:
a light guide bar comprising a light emitting surface and a plurality of reflecting surfaces, the light emitting surface comprising a light-scattering pattern;
a flexible printed circuit comprising a flexible plastic substrate and a plurality of conductive traces;
a light emitting diode light source module comprising at least one light emitting diode, the light emitting diode light source module attached to the flexible printed circuit; and
a reflective holder encasing a portion of the light guide bar, and the flexible printed circuit attached to the reflective holder

2. The linear light source assembly of claim 1, further comprising:
a plurality of flexible printed circuit holes disposed on the flexible printed circuit; and
a plurality of holder posts disposed on the reflective holder.

3. The linear light source assembly of claim 2, wherein the plurality of holder posts are inserted into the plurality of flexible printed circuit holes and hold the flexible printed circuit to the reflective holder and align the light emitting diode light source module to a light receiving end of the light guide bar.

4. The linear light source assembly of claim 1, the light emitting diode light source module further comprising:
a plurality of light emitting diode conductors for electrically coupling the plurality of conductive traces and the at least one light emitting diode.

5. The linear light source assembly of claim 1, the light emitting diode light source module comprising a surface-mount device.

6. The linear light source assembly of claim 1, the light emitting diode light source module attached to the flexible printed circuit by surface-mount soldering.

7. The linear light source assembly of claim 1, where the light-scattering pattern comprises a plurality of notches.

8. The linear light source assembly of claim 7, where the plurality of notches are formed on an outer surface of the light emitting surface.

9. The linear light source assembly of claim 7, wherein an incline angle of the plurality of notches on the light emitting surface is gradually and segmentally increased.

10. The linear light source assembly of claim 1, where an angle of the light-scattering pattern is gradually increased with an incline angle of 0.03 to 0.15 degrees.

11. A linear light source assembly, comprising:
a light guide bar comprising a light emitting surface and a plurality of reflecting surfaces, the light emitting surface comprising a light-scattering pattern;
a flexible printed circuit comprising a flexible plastic substrate, a plurality of conductive traces, and a plurality of flexible printed circuit holes in the flexible plastic substrate;
a light emitting diode light source module comprising at least one light emitting diode, the light emitting diode light source module attached to the flexible printed circuit; and
a reflective holder encasing a portion of the light guide bar, the reflective holder comprising a plurality of holder posts;
wherein the plurality of holder posts are inserted into the plurality of flexible printed circuit holes and hold the flexible printed circuit to the reflective holder and align the light emitting diode light source module to a light receiving end of the light guide bar.

12. The linear light source assembly of claim 11, the light emitting diode light source module further comprising:
a plurality of light emitting diode conductors for electrically coupling the plurality of conductive traces and the at least one light emitting diode.

13. The linear light source assembly of claim 11, the light emitting diode light source module comprising a surface-mount device.

14. The linear light source assembly of claim 11, the light emitting diode light source module attached to the flexible printed circuit by surface-mount soldering.

15. The linear light source assembly of claim 11, where the light-scattering pattern comprises a plurality of notches.

16. The linear light source assembly of claim 15, where the plurality of notches are formed on an outer surface of the light emitting surface.

17. The linear light source assembly of claim 15, wherein an incline angle of the plurality of notches on the light emitting surface is gradually and segmentally increased.

18. The linear light source assembly of claim 11, where an angle of the light-scattering pattern is gradually increased with an incline angle of 0.03 to 0.15 degrees.

19. A linear light source assembly, comprising:
a light guide bar comprising a light emitting surface and a plurality of reflecting surfaces, the light emitting surface comprising a light-scattering pattern, the light-scattering pattern comprising a plurality of notches;
wherein an incline angle of the plurality of notches of the light-scattering pattern on the light emitting surface is gradually and segmentally increased;
a flexible printed circuit comprising a flexible plastic substrate, a plurality of conductive traces, and a plurality of flexible printed circuit holes in the flexible plastic substrate;
a light emitting diode light source module comprising at least one light emitting diode and a plurality of light emitting diode conductors for electrically coupling the plurality of conductive traces and the at least one light emitting diode, the light emitting diode light source module comprising a surface-mount device, and the light emitting diode light source module attached to the flexible printed circuit by surface-mount soldering; and
a reflective holder encasing a portion of the light guide bar, the reflective holder comprising a plurality of holder posts;
wherein the plurality of holder posts are inserted into the plurality of flexible printed circuit holes and the holder posts are heat staked to hold the flexible printed circuit to the reflective holder and align the light emitting diode light source module to a light receiving end of the light guide bar.

20. The linear light source assembly of claim 19, where the incline angle of the light-scattering pattern is gradually increased from 0.03 to 0.15 degrees.
